(19) United States
(12) Patent Application Publication
(10) Pub. No.: US 2026/0132750 A1
(43) Pub. Date: May 14, 2026

(54) METHOD OF OPERATING A HYBRID AMMONIA-DIESEL COMPRESSION IGNITION PROPULSION SYSTEM AND/OR POWER GENERATION SYSTEM AND CONTROLLING THE POWER OUTPUT AND EMISSIONS THEREOF

(71) Applicant: Analytical Engineering, Inc., Columbus, IN (US)

(72) Inventors: David Francis May, Columbus, IN (US); Nicholas Hunter Karch, Columbus, IN (US); Katrina Ann Karch, Columbus, IN (US)

(73) Assignee: Analytical Engineering, Inc., Columbus, IN (US)

(21) Appl. No.: 19/381,239

(22) Filed: Nov. 6, 2025

Related U.S. Application Data
(60) Provisional application No. 63/718,191, filed on Nov. 8, 2024.

(51) Int. Cl. F02D 19/06; F02B 9/02; F02D 19/08; F02D 41/14; F02D 41/40

(52) U.S. Cl. CPC F02D 19/061; F02B 9/02; F02D 19/08; F02D 41/1441; F02D 41/1463; F02D 41/401

(57) ABSTRACT

A compression ignition engine system includes: a compression ignition engine which is configured for using ammonia as a primary fuel source and a compression ignition engine fuel as a secondary fuel source; and a control system operatively coupled with the compression ignition engine and configured for at least partially controlling a use of the ammonia and the compression ignition engine fuel by the compression ignition engine, the compression ignition engine system having an absence of an exhaust gas recirculation system or an absence of an exhaust gas recirculation system that functions.

### CROSS REFERENCE TO RELATED APPLICATIONS

This is a non-provisional application based upon U.S. provisional patent application Ser. No. 63/718,191, entitled “METHOD OF OPERATING A HYBRID AMMONIA-DIESEL COMPRESSION IGNITION PROPULSION SYSTEM AND/OR POWER GENERATION SYSTEM AND CONTROLLING THE POWER OUTPUT AND EMISSIONS THEREOF”, filed Nov. 8, 2024, which is incorporated herein by reference.

### BACKGROUND OF THE INVENTION

### 1. Field of the Invention

The present invention relates to engine systems, and, more particularly, to compression ignition engine systems.

### 2. Description of the Related Art

Internal combustion engines, and more specifically compression ignition engines, operate exclusively on carbon-based fuels as their main power source. Carbon-based fuels, such as diesel, gasoline, ethanol, and natural gas, offer many advantageous properties for their use in internal combustion engines—such as their ignitability, high energy density, and wide flammability range. Unfortunately, they also produce many greenhouse gas emissions, such as CO2 and NOx, and some poisonous gases such as CO.

In order to reduce the carbon footprint of industries that rely on internal combustion engines for propulsion or power generation, it would be desirable to develop an engine system that could use a non-carbon-based fuel as its primary fuel energy source. It would also be advantageous for that fuel to be readily available, easily transportable, safe, and easily manufactured. In addition, it would also be advantageous if the architecture and control of said near-zero CO2 emitting engine was simpler in nature than current diesel engines, whose architecture and control have become inherently complex in order to meet strict emissions standards. Some of these challenges include having to control an Exhaust Gas Recirculation (EGR) system and its associated control valves and flow measurements, the variable geometry turbocharger, the diesel high pressure common rail pressure, injection quantity (or quantities, for multiple injections), injection timing, post fueling quantity for regeneration of the diesel particulate filter (DPF), and urea dosing in the aftertreatment for the reduction of NOx (oxides of nitrogen, including NO and NO2) in the Selective Catalytic Reduction catalyst (SCR, which can also be referred to as an SCR catalyst), all simultaneously, where almost all have an impact on one another.

What is needed in the art is, with respect to compression ignition engine systems, a way(s) to simplify the control strategy, to reduce the number of components in the system, and to drastically reduce the greenhouse gas emissions.

### SUMMARY OF THE INVENTION

The present invention provides a compression ignition engine system including a compression ignition engine for using ammonia as a primary fuel source and a compression ignition engine fuel as a secondary fuel source and a control system operatively coupled with the compression ignition engine, the compression ignition engine system having an absence of an exhaust gas recirculation system or an absence of an exhaust gas recirculation system that functions.

The invention in one form is directed to a compression ignition engine system including: a compression ignition engine which is configured for using ammonia as a primary fuel source and a compression ignition engine fuel as a secondary fuel source; and a control system operatively coupled with the compression ignition engine and configured for at least partially controlling a use of the ammonia and the compression ignition engine fuel by the compression ignition engine, the compression ignition engine system having an absence of an exhaust gas recirculation system or an absence of an exhaust gas recirculation system that functions.

The invention in another form is directed to a control system for a compression ignition engine system including a compression ignition engine, the control system including: the control system, which is configured for being operatively coupled with the compression ignition engine—which is configured for using ammonia as a primary fuel source and a compression ignition engine fuel as a secondary fuel source—and for at least partially controlling a use of the ammonia and the compression ignition engine fuel by the compression ignition engine of the compression ignition engine system, which has an absence of an exhaust gas recirculation system or an absence of an exhaust gas recirculation system that functions.

The invention in yet another form is directed to a method of forming and using a compression ignition engine system, the method including the steps of: providing that the compression ignition engine system includes a compression ignition engine, which is configured for using ammonia as a primary fuel source and a compression ignition engine fuel as a secondary fuel source; operatively coupling a control system with the compression ignition engine; and controlling, at least partially, a use of the ammonia and the compression ignition engine fuel by the compression ignition engine, the compression ignition engine system having an absence of an exhaust gas recirculation system or an absence of an exhaust gas recirculation system that functions.

An advantage of the present invention is that it provides a compression ignition engine system that uses both ammonia and a compression ignition engine fuel (i.e., diesel) as fuel and that is able to control the power output and greenhouse emissions such as NOx.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a compression ignition engine system, including a compression ignition engine, an intake system, and an exhaust system, in accordance with an exemplary embodiment of the present invention;

FIG. 2 is a graph of diesel injection timing v. ammonia-NOx ratio (ANR), as well as a graph of diesel injection timing v. thermal efficiency, in accordance with an exemplary embodiment of the present invention;

FIG. 3 is a graph of air-fuel ratio (Lambda) v. ammonia-NOx ratio (ANR), in accordance with an exemplary embodiment of the present invention;

FIG. 4 is a graph of engine load (%) v. fuel energy share (%), in accordance with an exemplary embodiment of the present invention;

FIG. 5 is a graph of normalized engine load (%) v. fuel quantity, in accordance with an exemplary embodiment of the present invention;

FIG. 6 is a schematic representation of a control system of the compression ignition engine system, in accordance with an exemplary embodiment of the present invention;

FIG. 7 is a graph of engine load (%) v. desired ANR (from combustion), in accordance with an exemplary embodiment of the present invention;

FIG. 8 is a graph of engine load (%) v. diesel start of injection timing (according to crankshaft angle), in accordance with an exemplary embodiment of the present invention;

FIG. 9 is a schematic representation of a compression ignition engine system, in accordance with an exemplary embodiment of the present invention;

FIG. 10 is a graph of horsepower v. diesel substitution/BTE (Brake Thermal Efficiency), as well as horsepower v. NOx, in accordance with an exemplary embodiment of the present invention; and

FIG. 11 is a flow diagram of a method of forming and using a compression ignition engine system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

According to an exemplary embodiment of the present invention, the present invention provides a compression ignition engine system that includes a compression ignition engine that uses ammonia as the primary fuel and a compression ignition engine fuel as the secondary fuel. The compression ignition engine can be, for example, a compression ignition, conventional, modern diesel engine that is modified to burn ammonia as the primary fuel and the compression ignition engine fuel as the secondary fuel. Significantly, the engine of the present invention is a compression ignition engine—whether specifically a diesel engine or some other suitable compression ignition engine—that uses any suitable compression ignition engine fuel, such as (by way of example and not limitation) diesel fuel, a biodiesel fuel (any blend of biodiesel or 100% biodiesel), hydrogenated vegetable oil (HVO)(any blend of HVO or 100% HVO), any drop-in replacement for diesel fuel, any hydrocarbon-based fuel with cetane number or other thermophysical properties enabling or sufficient to support compression ignition, or any blend of traditional diesel fuel with biodiesel fuel, HVO, or any hydrocarbon-based fuel with cetane number or other thermophysical properties enabling or sufficient to support compression ignition, or blends thereof, the type of compression ignition engine typically referenced herein is a diesel engine and thus the type of fuel typically referenced herein is diesel fuel, but this is done by way of example and not limitation. Ammonia is a highly combustible gas at standard conditions and contains no carbon. Ammonia, or NH3, is a fuel that can be used resulting in the generation of gases including water vapor, nitrogen and, in some cases, some oxygen. There are other gases that can be generated including nitrogen oxide (NO), nitrogen dioxide (NO2), nitrous oxide (N2O), and unburnt or otherwise generated ammonia (NH3).

The present invention provides a solution to the following design criteria:
1. How to achieve combustion of a near-zero CO2 emissions internal combustion engine that utilizes ammonia as the primary fuel energy source (i.e., 5% diesel fuel energy at sufficiently advanced injection timing, though, as stated below, the 5% threshold is exemplary and could be higher or lower (i.e., 1-20%)).
2. How to control the power output of said near-zero CO2 emissions internal combustion engine that utilizes ammonia as the primary fuel energy source
3. How to control the emissions of said near-zero CO2 emissions internal combustion engine, that utilizes ammonia as the primary fuel energy source
4. The idea of utilizing combustion strategies and inherent engine out emissions of said engine, in order to allow removal of the urea injection system typically found on a diesel engine
5. How to utilize currently available diesel engines and aftertreatments to obtain near-zero CO2 emissions and currently acceptable NOx, NH3 (ammonia), CO, etc. emissions (and with the added benefit of being able to remove some components like EGR and urea injection)(EGR is a system that recirculates a portion of an engine's exhaust gas back into the combustion chamber to lower peak combustion temperatures, which in turn reduces the formation of harmful nitrogen oxides (NOx)).
   Hardware, Electrical, and/or Software Assumptions

The present invention provides structure and a method that assumes hardware is in place that is commonplace on modem diesel engines. This includes, at minimum: a common rail injection system capable of varying injection quantities, timing, and fuel pressure electronically and independently; NOx sensors upstream and downstream of the engine aftertreatment; and a selective catalyst reduction catalyst (SCR). Additionally, an ammonia oxidation catalyst (AMOX), a variable geometry turbocharger, and an intake air throttle are all optionally included. On the other hand, there is no apparent advantage to using Exhaust Gas Recirculation (EGR). The EGR system can be removed from the engine architecture altogether (an exemplary embodiment of the present invention provides that the EGR system has been removed or is rendered nonfunctioning). This will result in a substantial cost reduction as well as provide considerable improvements in terms of reliability, weight, and degraded performance. Thus, according to an embodiment of the present invention, the EGR system of the compression ignition engine system is removed. According to an alternative embodiment of the present invention, the EGR system is rendered nonfunctioning; that is, the EGR system exists (in whole or in part) but it does not function, because the EGR system has been made not to function, either permanently (that is, the EGR system cannot be made to function again) or temporarily (that is, the EGR system could be made to function again). In being made not to function, the EGR system can (by way of example and not limitation) have a passageway that is plugged so that exhaust gas cannot proceed therethrough, or a controller can be set so that the EGR system is not used as intended.

In addition to the required items that are found on modern diesel engines, the diesel engine—in accordance with the present invention—also must be upfit with ammonia sensors upstream and downstream of the engine aftertreatment and an ammonia injection system which may introduce ammonia in any number of locations (pre-compressor, post-compressor, throttle body, intake manifold, in-cylinder, etc.). For instance, according to an exemplary embodiment of the present invention, the compression ignition engine system includes the following in succession: ambient air (not part of the compression ignition engine system but flows through at least parts thereof)—a compressor of a turbocharger—a charge air cooler (which is optional)—an intake air throttle—an intake manifold of a compression ignition engine—a cylinder of the compression ignition engine—a turbine of the turbocharger (wherein the turbine can also be referred to as an exhaust turbine)—aftertreatment devices—system out. Thus, optional locations for ammonia injectors (injecting liquid or gaseous (vapor) ammonia) include the following: before the compressor of the turbocharger (i.e., in a flow passageway (which also can be referred to as a conduit) after receipt of ambient air; between the compressor of the turbocharger and the charge air cooler (such as in a flow passageway or conduit); between the charge air cooler and the intake air throttle (such as in a flow passageway or conduit); between the intake air throttle and the intake manifold (such as in a flow passageway or conduit); in the intake manifold; and/or in the cylinder.

The present invention can use existing electronics and software, and in addition, likely requires additional sensors—for sensing ammonia—and specifically developed software for optimizing injection rates, etc. It will be appreciated that any combination of electrical hardware, software, and/or firmware can be utilized in order to carry out the methodology of the present invention, as described herein.

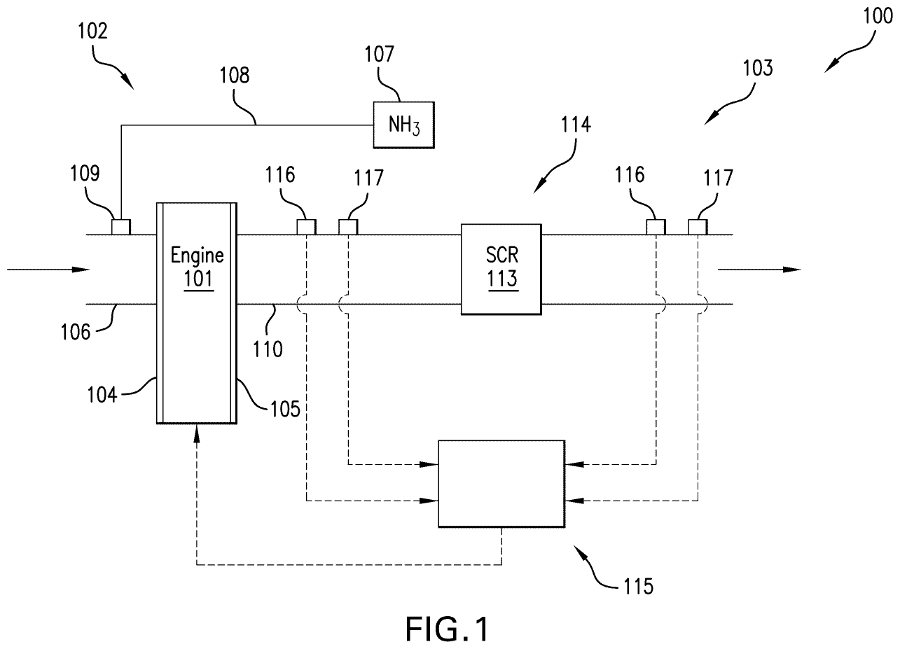

Referring now to FIG. 1, there is shown schematically a compression ignition system 100, with portions broken away, compression ignition system 100—which is configured for using ammonia as a primary fuel source and a compression ignition engine fuel (i.e., diesel) as a secondary fuel source—including a compression ignition engine (a diesel engine) 101, an intake system 102, and an exhaust system 103. Engine 101 includes an intake manifold 104 and an exhaust manifold 105. Intake system 102 is coupled with intake manifold 104 of engine 101 and includes an intake passageway 106 (which can also be referred to as a conduit) coupled with intake manifold 104, intake conduit 106 being configured for communicating air and, as necessary, ammonia to engine 101. Intake system 102 is shown to further include a storage tank 107 (which can store ammonia in liquid or gaseous (vapor) form), a passageway 108 (which can also be referred to as a conduit), and at least one ammonia injector 109 configured for injecting ammonia into intake conduit 106.

Exhaust system 103 is coupled with exhaust manifold 105 of engine 101 and includes an exhaust passageway 110 (which can be referred to as a conduit) carrying an exhaust stream (such as exhaust gas) away from engine 101, and, in the direction of the exhaust stream flow, to an SCR 113, and onward to an exhaust outlet where the exhaust stream is discharged into the surrounding atmospheric air. Exhaust system 103 thus includes an aftertreatment system 114 that includes any suitable devices (here, emission reduction devices), such as SCR 113. Though not shown in FIG. 1, exhaust system 103 can optionally further include a DOC, a DPF, and/or an N2O reduction catalyst, but each of these emission reduction devices would be positioned downstream of SCR 113.

Further, compression ignition engine system 101 further includes a control system 115 operatively coupled with compression ignition engine 101 and configured for at least partially controlling a use of the ammonia and the diesel fuel by compression ignition engine 101. In FIG. 1, control system 115 includes an ammonia sensor 116 and a 117 sensor upstream of emission reduction device 113 and includes an ammonia sensor 116 and a NOx sensor 117 downstream of emission reduction device 113, sensors 116, 117 being configured for sensing ammonia and NOx respectively in the exhaust stream and for outputting signals associated therewith to a controller (or controller system)(not shown in FIG. 1). Control system 115 further includes a controller 118 (which is an Engine Controle Module (ECM), which can also be referred to herein as the Engine Control Unit (ECU)) operatively coupled with sensors 116, 117 and engine 101.

Thus, in use, ammonia (such as vapor ammonia) is communicated from storage tank 107 through conduit 108 to intake conduit 106 where ammonia meets air (i.e., flowing from the compressor of a turbocharger), the air and ammonia mixture then flowing through intake conduit 106 to the combustion chamber of engine 101. The exhaust stream then exits engine 101, and at least a part thereof is treated by emission reduction device 113 before exiting exhaust conduit 110. Further, sensors 116, 117 output their signals to a controller (or controller system), which can subsequently output signals to control the operation of system 101 in a desired manner.

Thus, the architecture of system 100 allows for upfit of an ammonia system (i.e., storage tank 107, conduit 108, ammonia injector(s) 109, ammonia sensors 116) to an existing diesel engine, thereby reducing greenhouse gas emissions and still maintaining acceptable tailpipe emissions through a way of control and, further, a way of controlling power output. The proposed architecture contains: (1) one or more liquid (or vapor) ammonia injectors in the intake manifold 104 and/or air handling pipe(s) 106 upstream of the intake manifold 104 (FIG. 1 shows such an injector 109 in conduit 106 upstream of intake manifold 104); (2) removal of the EGR system (this removal includes the physical removal of the EGR system or the disabling of the EGR system so that the EGR system is not functional); (3) the addition of ammonia sensors (i.e., sensors 116) upstream and downstream of the aftertreatment (i.e., aftertreatment system 114 or parts thereof, such as device 113), for monitoring ammonia-to-NOx ratio (ANR) and ammonia slip.

### Operation/Control

The present invention provides structure and a method that controls the introduction of ammonia into the air induction stream or directly in-cylinder (the ammonia not being compression-ignitable on its own at the compression ratios of commercially available diesel engines) and that ignites the ammonia through the control of a small amount of diesel injected directly in-cylinder, either into the main combustion chamber or a pre-chamber, wherein the control of injection timing of said diesel is sufficiently advanced to obtain good combustion efficiency (because of ammonia's very slow flame speed compared to diesel or gasoline), and more importantly, wherein the molar ratios of NH3 to NOx are near 1:1 in the exhaust in order to obtain reduction of NH3 and NOx into nitrogen and water in the SCR catalyst, which eliminates the need for a separate urea injection system that traditionally provides the NH3 in the exhaust aftertreatment for the reduction of NOx and NH3 into nitrogen and water.

The present invention uses the combustion byproducts inherent with respect to a hybrid ammonia-diesel compression ignition engine to advantage by controlling the ratio of said byproducts with levers (factors) available on a modern diesel engine. These byproducts primarily include NOx and NH3, which when controlled to a certain ratio, allow for reduction of said emissions in an SCR catalyst. The primary control method is be to use the start of injection timing of the diesel pilot ignition source to meet the desired ANR of the system.

### Findings/Data

Given the stated engine and ammonia injection architecture and the ability to control the diesel fuel system, experiments were conducted in TC206 at Analytical Engineering, Inc. on a Cummins X15 engine utilizing a range of fuel pressures, start of injection timing, injection quantities, and the percent of total fuel energy that is contributed with ammonia (ammonia energy share). Ammonia energy share (AES) is obtained with the following calculation, utilizing fuel mass flow and lower heating value (LHV):

$$AES = \frac{NH 3 fuel rate ( \frac{kg}{hr} ) * NH 3 LHV ( \frac{MJ}{kg} )}{\begin{matrix}( NH 3 fuel rate ( \frac{kg}{hr} ) * NH 3 LHV ( \frac{MJ}{kg} ) ) + \\ ( diesel fuel rate ( \frac{kg}{hr} ) * diesel LHV ( \frac{MJ}{kg} ) )\end{matrix}}$$

The Ammonia-NOx ratio (ANR) is the measured NH3 (ppm) in the exhaust divided by the measured NOx (ppm) in the exhaust. These measurements were obtained by an FTIR (Fourier Transform Infrared spectroscopy). The ratio of Ammonia/NOx (ANR) is especially important for the reduction of NOx in the SCR catalyst. NH3 provides nitrogen and hydrogen to reduce NOx into N2 and H2O. Traditionally, on a modern diesel engine, the combination of measured NOx in the exhaust before the aftertreatment and a corresponding ANR target table that is tuned by the performance and emissions engineer developing the engine platform will decide how much urea is to be injected into the exhaust stream before the SCR. This ANR target is a balance of obtaining good conversion efficiency and having little ammonia slip (NH3 that does not react with NOx in the SCR catalyst).

$$NOx measured * \frac{NH 3}{NOx} ( ANR command ) = NH 3 command$$

A problem which has plagued diesel engine and aftertreatment manufacturers alike is the ability to reliably inject a known amount of urea into the exhaust aftertreatment, have sufficiently good mixing so that the NOx reduction is maximized and the NH3 slip is minimized, and not have urea crystals forming on the injector and in the exhaust aftertreatment urea mixing section. Significant development time and money is spent on these issues. In addition, the truck (here, an exemplary vehicle with a diesel engine) also has to be upfit with a urea tank to store urea, and the urea quality and temperature has to be monitored. It would be very advantageous to be able to get rid of these components entirely and to keep the same emissions performance.

According to the present invention, the ANR desired is be controlled directly by way of combustion control. Through experimentation, it was discovered that many levers (factors) have an impact on the engine's ANR output in the exhaust—such as fuel rail pressure, injection timing, air-fuel ratio, as well as the number of fuel injections and their associated fuel quantity share and separation from the main injection. The lever which has the greatest influence on ANR was found to be the diesel injection timing. Through variation on main injection timing alone, ANR was easily varied between 4 and 0.9. The ideal ANR is typically around 1, which is conveniently where the engine's thermal efficiency is also near its peak. This way of operation/control could be used to target virtually any ANR desired that is appropriate for the given exhaust aftertreatment system.

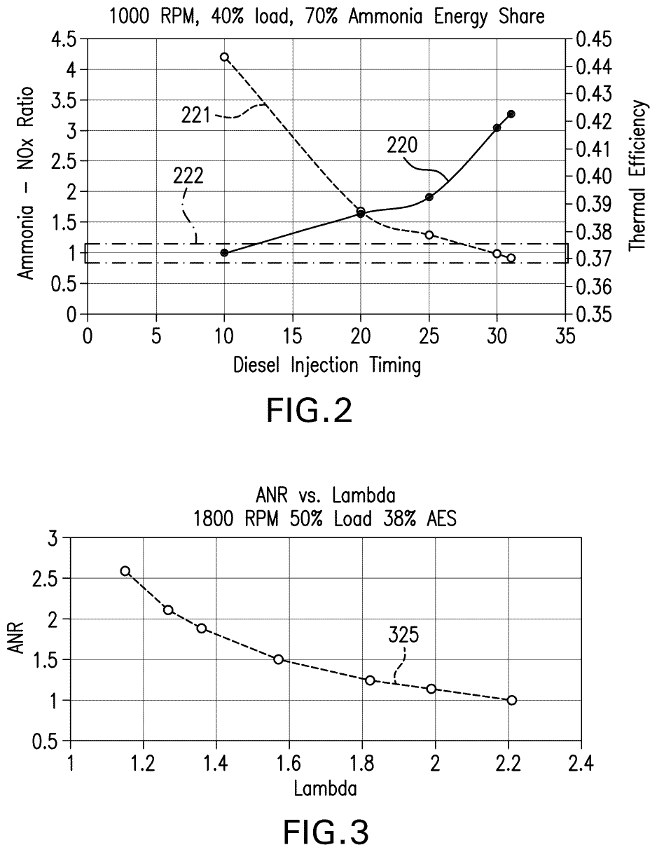

Referring now to FIG. 2, there is shown a graph of diesel injection timing v. ammonia-NOx ratio (ANR), as well as a graph of diesel injection timing v. thermal efficiency, thereby illustrating the effect of diesel injection timing (in terms of crankshaft angle relative to Top Dead Center) on ANR and thermal efficiency (at 1000 RPM, 40% load, 70% ammonia energy share). FIG. 2 shows thermal efficiency as line 220, ANR as line 221, and the desired ANR as a box 222.

Referring now to FIG. 3, there are shown test results in the form of a graph of air-fuel ratio (Lambda) v. ammonia-NOx ratio (ANR), thereby illustrating the effect of air-fuel ratio on ANR, at 1800 RPM, 50% load, and 38% AES (Ammonia Energy Share). As indicated herein, air-fuel ratio is a way to control ANR. Line 325 shows this relationship.

### Further Regarding Operation/Control

Engine Starting/Warmup. Since there is a traditional diesel injection system on board, the engine is started like a traditional diesel engine, that is, on diesel fuel alone. The engine continues to run on diesel until the aftertreatment is sufficiently warmed up to catalyze reactions.

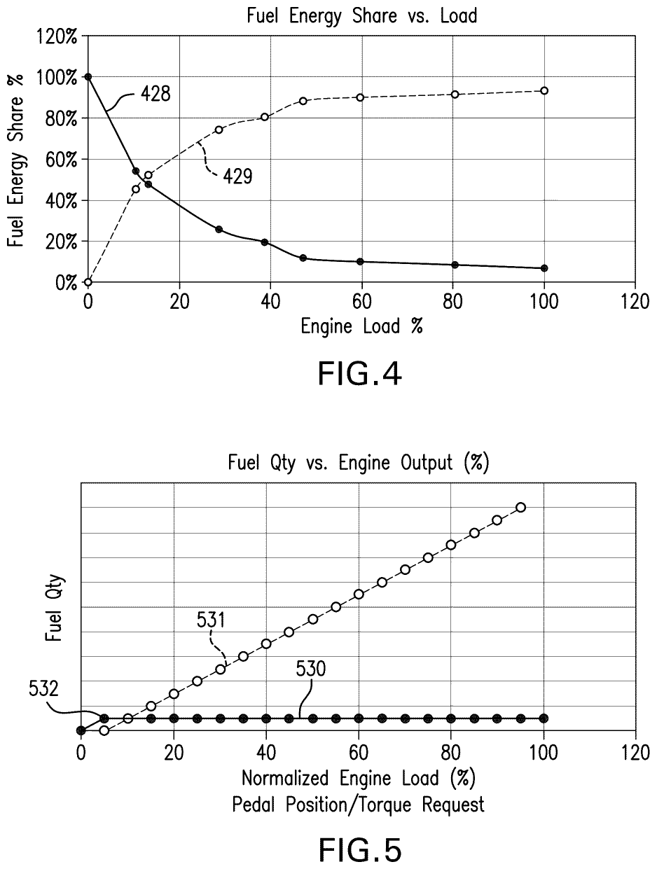

Engine Power Output. The control of diesel and ammonia quantities and energy shares versus engine load looks like the plots below (FIGS. 4 and 5), where 100% engine load is the maximum torque the engine can produce and 0% engine load is full motoring, wherein the engine is not producing any combustion torque but is being motored by the propulsion system drivetrain (such as coasting down a hill). There exists a minimum diesel fuel energy share, because of ammonia's non-ignitability through compression ignition alone, which in this case is shown as 5% fuel energy, but could be anywhere from 1-90%. The minimum amount of fuel that can be reasonably injected by the diesel or ammonia system may shape the curve differently at low loads. The engine runs on diesel alone at idle and at very low loads, shown in FIG. 4 as 5% load or less, but the switch point where ammonia starts to be injected can be as low as 0% load or as high as 90% load. At or above the switch point the engine begins ammonia fueling, which is described as the dual-fuel operating range (wherein the engine operates in the dual-fuel operating mode). At or below the switch point the engine begins ammonia fueling, which is described as the diesel-only operating range (wherein the engine operates in the diesel-only operating mode). At engine load requests lower than the dual-fuel operating range, primarily diesel fuel is added in order to increase power output. At engine load requests higher than the diesel-only operation, primarily ammonia is added in order to increase power output. Above the diesel-only operating range, the diesel fuel is gradually reduced to 5% energy share at 100% load, as shown in FIG. 4 but could be reduced to as low as 1% energy share or as high as 90% energy share due to combustion and emissions considerations. The decrease in diesel energy share above the diesel-only operating range is mainly achieved by increasing the ammonia fueling rate as load increases.

Referring now to FIG. 4, there are shown test results in the form of a graph of engine load (%) v. fuel energy share (%). The line pertaining to ammonia as fuel is shown as line 428, and the line pertaining to diesel fuel is shown as line 429.

Referring now to FIG. 5, there is shown a graph of normalized engine load (%) v. fuel quantity. The line pertaining to diesel fuel is shown as line 530, and the line pertaining to ammonia as fuel is shown as line 531.

Accordingly, the present invention provides structure and a method of controlling power output of an ammonia-diesel hybrid compression ignition engine. The engine uses an increasing amount of diesel fuel up to a certain point (532, in FIG. 5), after which ammonia is injected to increase power output. Since injection timing (of diesel fuel) depends heavily on if and how much ammonia is being injected, the injection timing is a function of ammonia quantity—energy share, mass flow, etc.

Control of System out NOx and NH3 Emissions through control of engine out ANR. In order to control the reduction of NOx in the SCR, the engine out ANR is controlled through the engine combustion strategy, which includes but is not limited to: start of injection timing; number of injection pulses; separation of injection pulses; fuel share of injection pulses; diesel fuel quantity/energy share; air-fuel ratio; and boost pressure (variable geometry turbocharger control); and engine deltaP (which is the difference between intake pressure and exhaust pressure and which can be affected with intake or exhaust throttles (valves), wastegate, and/or a variable geometry turbocharger). For this, the example of using start of injection timing as the primary control lever for ANR is used. Through the control of engine out ANR, the urea injection system typically found on diesel engines can be removed.

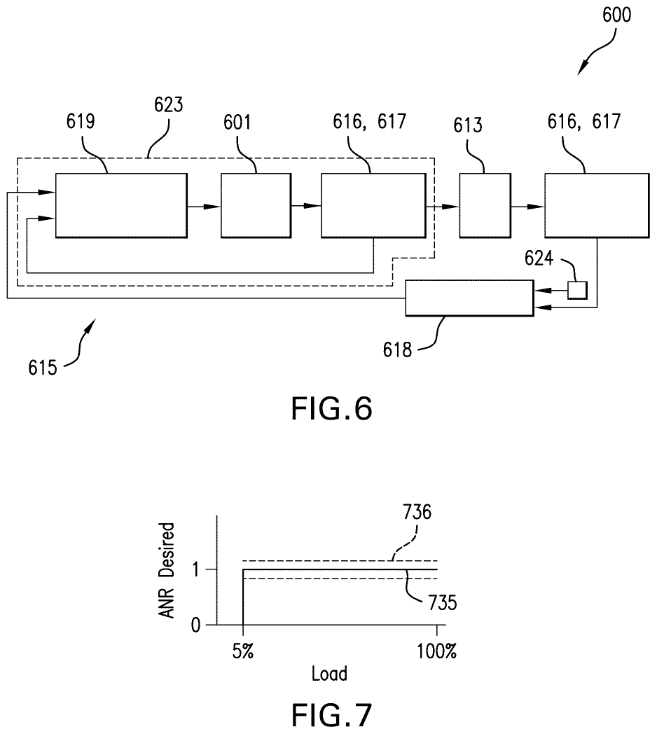

Further, referring now to FIG. 6, there is shown schematically a control system 615 of the compression ignition engine system 600, according to an exemplary embodiment of the present invention. Structures of system 600 that are substantially similar in structure and function to structures of system 100 are raised by a multiple of 100, unless stated otherwise. System 600 includes control system 615 and SCR 613 (an aftertreatment device), control system 615 being operatively coupled with a compression ignition engine 601. Control system 615 includes ammonia sensor 616 and NOx sensor 617 upstream of SCR 613, ammonia sensor 616 and NOx sensor 617 downstream of SCR 613, a first controller 618 (which is the ECM), and ANR controller 619 (associated with start of injection of diesel fuel). Control system 618 has an inner loop 623 (an inner control loop) as well as one or more other additional devices 624 submitting input signals to controller 618.

Further, engine out (first) NOx and NH3 sensors 616, 617 in the engine exhaust (before the aftertreatment) measure respectively the engine out NOx and NH3 for calculating the engine out ANR (which can be calculated in a controller 619 (an inner loop controller) of the control system 615 of the compression ignition engine system 600), and the controller 619 compares that actual ANR (calculated from the data provided by the engine out NOx and NH3 sensors 616, 617) with a desired engine out ANR that will achieve maximum reduction of system out (after the aftertreatment) NOx and minimum NH3 slip. Based on the error of actual to desired ANR, the controller 619 varies the start of injection timing to achieve the desired engine out ANR. Further, system out (second) NOx and NH3 sensors 616, 617 in the engine exhaust (but after the aftertreatment) measure respectively the system out NOx and NH3. Utilizing this data (from system out NOx and NH3 sensors 616, 617) and possibly data from other sensors 624, a controller 619 (an outer loop controller) of the control system 615 of the compression ignition engine system varies the inner loop ANR command (an output of the inner loop controller 619, such as with respect to the start of injection timing of the diesel fuel) in order to achieve the desired NOx and NH3 system out numbers. This outer loop controller 618 compensates for system drift, system-to-system variation, and non-optimized ANR commands so that system out NOx and NH3 is always minimized.

Referring now to FIG. 7, there is shown a graph of engine load (%) v. desired ANR (from combustion). The graph shows that from 0-5% engine load the desired ANR is 0. This portion of the graph refers to the diesel-only operating range, where there is no ammonia being injected for combustion; therefore, the ANR from combustion must be zero. The 5% threshold is exemplary and could be higher or lower (i.e., 0-20%). From 5-100% engine load, the desired ANR is 1.0, as shown by line 735. Further, the dashed lines 736 show the outer loop control bounds (the outer loop including controller 618 (FIG. 6) and structures operatively coupled therewith), these dashed lines 736 suggesting the desired ANR can be somewhat greater or less than 1.0.

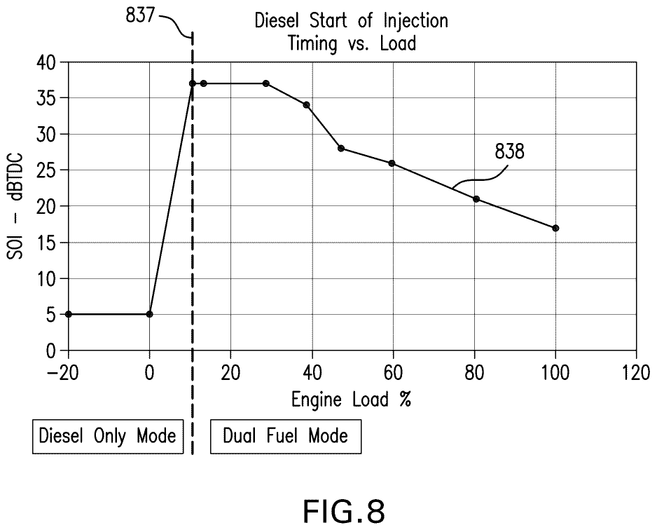

Referring now to FIG. 8, there are shown test results in the form of a graph of engine load (%) v. diesel start of injection timing (according to crankshaft angle), which corresponds to a feed-forward SOI (start of injection timing) table. Vertical dashed line 837 is shown in FIG. 8. To the left of line 837 is the diesel-only operating mode; to the right of line 837 is the dual-fuel operating mode. The graphed solid line 838 shows SOI timing relative to the percentage of engine load.

In a traditional diesel engine, total diesel fuel injection quantity and start of injection timing are used to control torque output. According to the present invention, primarily the injection quantity of ammonia will be used to control torque output in dual-fuel mode.

According to an embodiment of the present invention, the compression ignition engine system of the present invention can utilize an open-loop, or feed-forward, table which characterizes engine out ANR versus diesel injection timing, which will be used when changing ANR commands quickly, such as transient operation, wherein the inner loop controller (619) does not have time to react to the control error to obtain desired ANR, so that the engine can run close to the desired ANR without having to wait for the control loop to reduce the error.

According to another embodiment of the present invention, this functionality can also be “baked in” to combustion control strategies, i.e., if start of injection timing and desired ANR are both a function of speed and load request, the SOI (start of injection) table can be tuned in such a way that the commanded SOI always meets the desired ANR at a given speed and load (not accounting for system variation and drift). In this embodiment, it could be possible to remove the ammonia sensor (116) upstream of the SCR (113). The idea, though, remains the same of utilizing SOI to control ANR.

Retrofit of existing engines in the marketplace. Since the current invention is largely less complicated than existing modern diesel engines and utilizes modern diesel engine's existing equipment, a retrofit (in accordance with the present invention) of existing diesel engines in the marketplace is possible. The retrofit of existing engines in the marketplace uses the control strategies and operational ways described or suggested herein. These strategies are put in place in the ECM. Below is a list of steps/requirements to retrofit an existing diesel engine in a truck (or, more generally, a vehicle) or power generator application:
1. Upfit of ammonia storage tank (i.e., 107) and feed line (i.e., 108) to transfer ammonia from storage tank to ammonia injector (i.e., 109).
2. Upfit of ammonia injector onto existing engine. This could be done in a number of ways, i.e., by swapping to an intake manifold that has provisions for mounting of an ammonia injector, drilling/tapping the existing intake manifold, or replacing charge piping with pipes that have provisions for injector mounting.
3. Download new ECM calibration.
4. Install new exhaust aftertreatment+additional ammonia sensors in the exhaust stream.
5. Optional—remove charge air cooler.
6. Optional—remove/plug EGR system (or force EGR to 0 with ECM).
7. Optional—remove urea storage and injection system.
8. Install new wiring harness for new ammonia injector and sensors.

The operating range of diesel start-of-injection timing of this hybrid diesel-ammonia engine system of the present invention varies widely. A nominal diesel operating range (diesel fuel only) for diesel fuel injection timing (in terms of crankshaft angle) is approximately 0 to 10 dBTDC. On the other hand, the ammonia-diesel operating range with ANR of 1:1 for diesel injection timing can range from approximately 40 to 15 dBTDC, which is sufficiently advanced compared to nominal diesel operation.

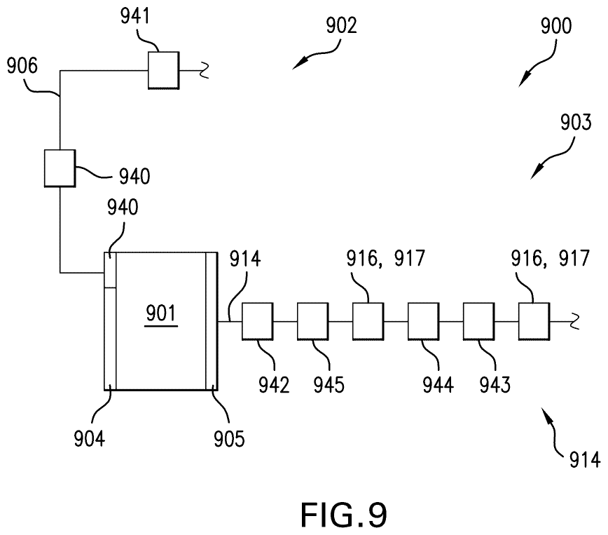

Referring now to FIG. 9, there is shown schematically a compression ignition engine system 900, according to another exemplary embodiment of the present invention. Structures of system 900 that are substantially similar in structure and function to structures of systems 100, 600 are raised by a multiple of 100, unless stated otherwise. System 900 includes compression ignition engine 901 (including intake manifold 904 and exhaust manifold 905), intake system 902 (which includes intake conduit 906), and exhaust system 903 (which includes exhaust conduit 910 and aftertreatment system 914). System 900 (in particular, intake system 902) includes a structure 940 for heating intake air used by engine 901, structure 940 being a heat exchanger or an electric heater. Structure 940 can be a part of or attached to intake manifold 904 of engine 901 or can be associated with intake conduit 906, or system 900 can have a plurality of structures 940 which can be located in either position. Structure 940 can be, for example, a heat exchanger using waste heat from coolant, oil, or exhaust gas or can be an electrical heater, or any other suitable device. Further, system 900 includes a structure 941 configured for modifying an air-fuel ratio, structure 941 being, for example, a variable geometry turbocharger, a wastegate, an intake throttle (which can be referred to as a throttle body), an exhaust throttle valve (specifically numbered as 945 in FIG. 9 but can be subsumed under 941), or other suitable device. Further, exhaust system 903 can include an oxygen sensor 942 configured for sensing oxygen in an exhaust stream in order to control an air-fuel ratio (oxygen sensor 942 can be located in any suitable location in exhaust stream). Further, exhaust system 903 can include at least one emission reduction device 943 and ammonia and NOx sensors 916, 917 upstream and/or downstream of the at least one emission reduction device 943. Further, exhaust system 903 can include an ammonia injection device 944 configured for injecting ammonia into the exhaust stream, so as to supply ammonia to an SCR (which can be a device 943) in order to control emissions. Further, exhaust system 903 can include one or more emission reduction devices 943 (if a plurality of devices 943 are used, these devices can be different from one another and spaced apart from one another along exhaust conduit 910), including: (a) an SCR; (b) an SCR, followed by an Ammonia Oxidation Catalyst (AMOX); (c) an SCR or a combination of an SCR and an AMOX (SCR/AMOX combination), followed by a DOC; (d) an SCR or an SCR/AMOX combination, followed by a DOC and then a DPF; or (e) an N2O reduction catalyst in any of (a)—(d) but after the SCR.

Accordingly, in general, the present invention provides a compression ignition engine system 100, 600, 900 (i.e., a diesel engine system) that runs on primarily ammonia fuel and secondarily on some diesel fuel. According to an embodiment of the present invention, a conventional compression ignition engine system 100, 600, 900 can be converted to run on primarily ammonia fuel and secondarily on some diesel fuel; alternatively, according to another embodiment of the present invention, rather than being so converted, the compression ignition engine system 100, 600, 900 can be manufactured to run on primarily ammonia fuel and secondarily on some diesel fuel. The former is assumed in the following unless stated or suggested otherwise. Thus, the compression ignition engine system 100, 600, 900 is externally modified for introduction of gaseous or liquid ammonia upstream of the intake ports of the diesel engine 101, 601, 901. Further, the present invention provides that the compression ignition engine system 900 can optionally further include structure 940 configured for raising the temperature of intake air and structure 941 configured for reducing the air-fuel ratio (AFR) (for example, using a wastegate, which is a valve—controlling exhaust gas to a turbine of a turbocharger—in a turbocharged system that can be understood to control boost pressure by diverting exhaust gases to bypass the turbine wheel when a predetermined pressure is reached). The aftertreatment system 114, 914 of the compression ignition engine system 100, 600, 900 is modified to eliminate the EGR system (at least the functionality thereof). Further, the aftertreatment system 114, 914 can omit a DOC and a DPF or can position the DOC and the DPF after the SCR 113.

As indicated, according to the present invention, the compression ignition engine system 100, 600, 900 can have structure(s) 940, 941 to modify the intake manifold temperature and the air-fuel ratio. Regarding the intake manifold temperature being modified, the intake manifold temperature can be heated by coolant, oil, or exhaust gas heat, such as by way of a heat exchanger, or by way of an electric heater, for example. Thus, for instance, liquid ammonia can be vaporized by a heat exchanger using waste heat from coolant, oil, or exhaust gas or by any other intake manifold heating device. Regarding the air-fuel ratio being modified, the air-fuel ratio can be controlled to as low as near stoichiometric (Lambda 1-2) via the variable geometry turbocharger, a wastegate, an intake throttle, an exhaust throttle, or other ways.

Further, according to additional embodiments of the present invention, the compression ignition engine system 100, 600, 900 may have one or more of the following:
1. Heating of the charge air by way of electricity, either in addition to or in place of heating the charge air through waste heat of coolant, oil, or exhaust.
2. Air-to-air charge air cooler (CAC) removed or bypassed.
3. An ammonia injection device (separate from ammonia injection into the intake of the diesel engine), where ammonia injection into the exhaust occurs in order to control emissions during diesel-only mode, or dual-fuel mode, to supply ammonia for the SCR 113, 943.
4. A vapor ammonia injection system (as an alternative to a liquid ammonia injection system), where heating of the intake air through waste heat and/or electrical heat may or may not be implemented, but where charge air cooling would be removed.
5. An O2 sensor 942 in the exhaust system to sense oxygen in the exhaust gas, for closed loop control of the air-fuel ratio or for monitoring the air-fuel ratio, where the controlled value would be much lower than typical on a conventional diesel engine system. The controlled value is a targeted air-fuel ratio (which can be a wide range and is based on the engine's (101, 601,901) operating point), where the O2 sensor 942 provides a measured air-fuel ratio as feedback to a controller controlling the air-fuel ratio, which can be as low as Lambda of 1.
6. The compression ignition engine 101, 601, 901 may use the former EGR outlet of an exhaust manifold (of the compression ignition engine) as a wastegate path (if the engine originally had an EGR).

Accordingly, the present invention provides structure and a method for controlling power output, NOx emissions, and unburned ammonia emissions of a dual-fuel ammonia-diesel compression ignition engine system 100, 600, 900, wherein the engine out ammonia-to-NOx ratio (ANR) is controlled to near 1.0 (0.85-1.15), wherein the ammonia energy share for combustion torque is anywhere from 0% to 99%, and a NOx SCR catalyst is used to reduce NOx in the exhaust. Further, ANR is either directly measured (for example, by way of sensors 116, 616, 916, 117, 617, 917) or is “virtually” measured, through a combination of look-up tables and sensors (for example, 116, 616, 916, 117, 617, 917) before and/or after the aftertreatment (more specifically, the emission reduction device(s) 943). Further, the ammonia for reacting with NOx in the exhaust is (a) injected upstream of the power cylinder (the respective cylinder within the compression ignition engine 101, 601, 901) and burned, and subsequently some unburned ammonia enters into the exhaust stream, or (b) the ammonia is injected directly into the exhaust stream for reduction of NOx in the SCR catalyst 113, 613, 943 with ammonia at the controlled ANR (using a target ANR). Further, ANR is increased or decreased, primarily through diesel injection timing, based on the sensed or virtually sensed performance of the catalyst's (for example, the SCR catalyst) NOx conversion efficiency and ammonia slip.

Further, ANR can be controlled by: (a) advancing or retarding diesel injection timing, wherein diesel injection timing can be anywhere from 50 dBTDC to −10 dBTDC, wherein the modification of the diesel injection timing can be to a single pulse or multiple injection pulses; and/or (b) adjusting air-fuel ratio, by: (i) adjusting ammonia and/or diesel quantity; (ii) adjusting intake manifold temperature/pressure, through a wastegate, variable geometry turbocharger position (i.e., the position of turbine vanes), and/or charge air heating; (iii) intake throttle; (iv) exhaust throttle valve (945); and/or (v) any way of modifying volumetric efficiency.

Further, the power output of the compression ignition engine 101, 601, 901 of the present invention can be controlled by: (a) increasing or decreasing diesel quantity at low engine load requests; (b) primarily increasing or decreasing ammonia quantity at engine load requests higher than the diesel-only operation; and/or (c) for any engine torque request, the ECM (118) decides what the ideal fuel energy split between ammonia and diesel is.

Further, characteristics of the control strategies include the following: (a) air/fuel ratio is reduced as ammonia energy share increases; (b) diesel injection timing is advanced in dual-fuel mode compared to diesel-only mode; (c) in dual fuel mode, diesel injection timing is retarded as load increases; (d) the air fuel ratio in “dual fuel mode” is lower than in diesel-only mode; (e) an oxygen sensor (942) in the exhaust stream can be used to correct the ammonia fueling or boost pressure to achieve the desired air-fuel ratio; and (f) diesel injection timing is retarded as intake manifold temperature increases.

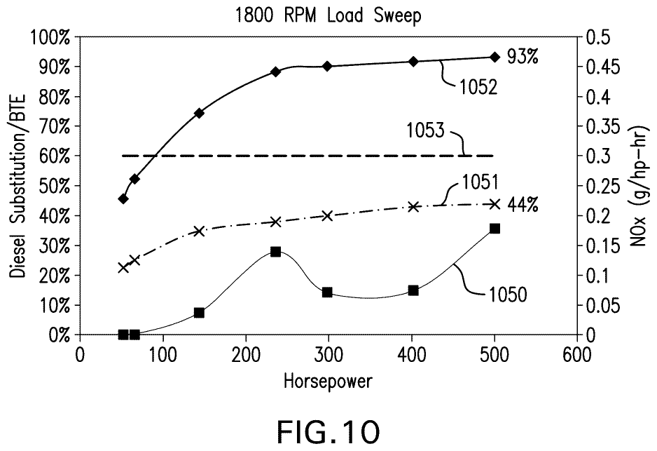

Referring now to FIG. 10, there are shown test results in the form of a graph of horsepower v. diesel substitution/BTE (Brake Thermal Efficiency), as well as horsepower v. system out NOx, at a constant engine speed of 1800 RPM, in accordance with an exemplary embodiment of the present invention. Stated another way, FIG. 10 shows ammonia share percentage as a function of torque at a constant speed of 1800 RPM. Line 1050 shows system out NOx emissions. Line 1051 shows thermal efficiency. Line 1052 shows diesel substitution. Line 1053 shows Tier 4 final NOx standard. Advantageously, the present invention provides 90% diesel substitution over a range of speeds and loads, NOx emissions below the required Tier 4 final levels, and no sacrifice between BTE and emissions.

Further, a compression ignition engine system 100, 600, 900 includes: a compression ignition engine 101, 601, 901 which is configured for using ammonia as a primary fuel source and a compression ignition engine fuel as a secondary fuel source; a control system 115, 615 operatively coupled with the compression ignition engine 101, 601, 901 and configured for at least partially controlling a use of the ammonia and the compression ignition engine fuel by the compression ignition engine 101, 601, 901, the compression ignition engine system 100, 600, 900 having an absence of an exhaust gas recirculation system or an absence of an exhaust gas recirculation system that functions. Optionally, control system 115, 615 is configured for controlling an ammonia-NOx ratio (ANR) downstream of the compression ignition engine 101, 601, 901 at least in part by advancing or retarding a compression ignition engine fuel injection timing. Optionally, control system 115, 615 is configured such that at least one of: (a) the compression ignition engine fuel (i.e., diesel) injection timing is advanced in dual-fuel operating mode compared to compression ignition engine fuel (i.e., diesel) only operating mode; (b) in a dual-fuel operating mode, the compression ignition engine fuel (i.e., diesel) injection timing is retarded as a load on the compression ignition engine 101, 601, 901 increases; and (c) the compression ignition engine fuel (i.e., diesel) injection timing is retarded as an intake manifold temperature increases; and (d) an air-fuel ratio is closer to stoichiometric in the dual-fuel operating mode compared to the compression ignition engine fuel-only operating mode. Optionally, control system 115, 615 is configured for controlling the ammonia-NOx ratio downstream of the compression ignition engine 101, 601, 901 at least in part by adjusting an air-fuel ratio. Optionally, compression ignition engine system 100, 600, 900 further includes an exhaust system 103, 903 which is coupled with the compression ignition engine 101, 601, 901 and includes at least one emission reduction device 943, 113, 613, wherein the control system 115, 615 includes a first NOx sensor 117, 617, 917, a first ammonia sensor 116, 616, 916, a second NOx sensor 117, 617, 917, and a second ammonia sensor 116, 616, 916, the first NOx sensor 117, 617, 917 and the first ammonia sensor 116, 616, 916 being positioned upstream of the at least one emission reduction device 943, 113, 613, the second NOx sensor 117, 617, 917 and the second ammonia sensor 116, 616, 916 being positioned downstream of the at least one emission reduction device 943, 113, 613 (sensors 116, 616, 916, 117, 617, 917 downstream of the at least one emission reduction device 943 are downstream of at least SCR 113, 613, alternatively of SCR 113, 613 and another emission reduction device 113, 613, alternatively of all emission reduction devices 943). More broadly (and thus alternatively), the plurality of sensors 116, 616, 916, 117, 617, 917 include at least one sensor 116, 616, 916, 117, 617, 917 positioned upstream of the at least one emission reduction device 943, 113, 613 and at least one sensor 116, 616, 916, 117, 617, 917 positioned downstream of the at least one emission reduction device 943, 113, 613, the at least one sensor 116, 616, 916, 117, 617, 917 positioned upstream of the at least one emission reduction device 943, 113, 613 being NOx sensor 117, 617, 917 or ammonia sensor 116, 616, 916, the at least one sensor 116, 616, 916, 117, 617, 917 positioned downstream of the at least one emission reduction device 943, 113, 613 being NOx sensor 117, 617, 917 or ammonia sensor 116, 616, 916; for example (and not limitation), the plurality of sensors 116, 616, 916, 117, 617, 917 may lack the ammonia sensor 116, 616, 916 positioned upstream of the at least one emission reduction device 943, 113, 613 but have the NOx sensor 117, 617, 917 positioned upstream of the at least one emission reduction device 943, 113, 613 and the NOx sensor 117, 617, 917 and the ammonia sensor 116, 616, 916 positioned downstream of the at least one emission reduction device 943, 113, 613. Optionally, control system 115, 615 is configured for controlling a power output of the compression ignition engine 101, 601, 901 at least in part by at least one of: (a) increasing or decreasing a quantity of the compression ignition engine fuel at a plurality of engine load requests that are low, that is, below the dual-fuel operating range; (b) increasing or decreasing a quantity of ammonia at a plurality of engine load requests higher than a compression ignition engine fuel-only operating mode; and (c) determining an ideal fuel energy split between the ammonia and the compression ignition engine fuel.

In general, controllers 118, 618, 619 each may correspond to any suitable processor-based device(s), such as a computing device or any combination of computing devices. Thus, each controller may generally include one or more processor(s) and associated memory configured to perform a variety of computer-implemented functions (e.g., performing the methods, steps, algorithms, calculations and the like disclosed herein). For instance, controllers 118, 618, 619 may each include a respective processor therein, as well as associated memory, data, and instructions, each forming at least part of respective controller 118, 618, 619. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, memory may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD), and/or other suitable memory elements. Such memory 223 may generally be configured to store information accessible to the processor(s), including data that can be retrieved, manipulated, created, and/or stored by processor(s) and instructions that can be executed by the processor(s). In some embodiments, data may be stored in one or more databases.

In use, ammonia and air, and diesel fuel as necessary, is communicated to the combustion chamber of engine 101, 601, 901. Heater 940 can be used to heat the air and/or ammonia in intake conduit 106, 906 and/or in the intake manifold of engine 101, 601, 901, and/or structure 941 can be used to control the air-fuel ratio. Further, after combustion, the exhaust stream is used in connection with a turbocharger and/or proceeds through exhaust conduit 110, 910 to an outlet to atmospheric air, after encountering oxygen sensor 942, exhaust throttle valve 945, sensors 116, 616, 916, 117, 617, 917, ammonia injector(s) 944, and/or emission reduction devices 943.

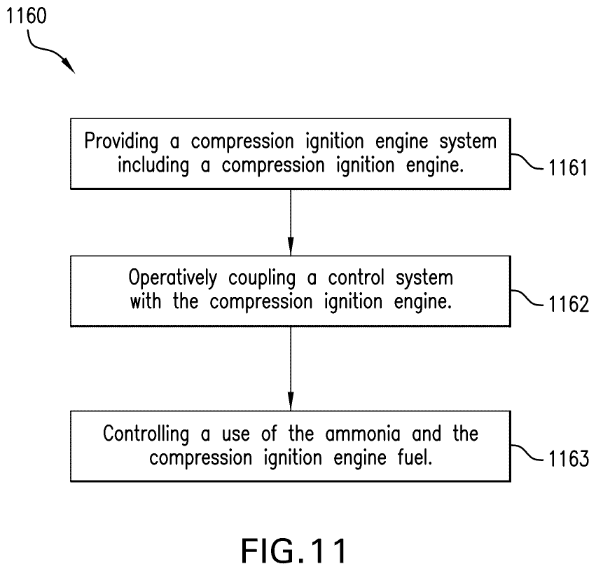

Referring now to FIG. 11, there is shown a flow diagram of a method 1160 of forming and using a compression ignition engine system 100, 600, 900. Method 1160 includes the steps of: providing 1161 that the compression ignition engine system 100, 600, 900 includes a compression ignition engine 101, 601, 901, which is configured for using ammonia as a primary fuel source and compression ignition engine fuel as a secondary fuel source; operatively coupling 1162 a control system 115, 615 with the compression ignition engine 101, 601, 901; and controlling 1163, at least partially, a use of the ammonia and the compression ignition engine fuel by the compression ignition engine 101, 601, 901, the compression ignition engine system 100, 600, 900 having an absence of an exhaust gas recirculation system or an absence of an exhaust gas recirculation system that functions. Optionally, control system 115, 615 is configured for controlling an ammonia-nitrogen ratio downstream of the compression ignition engine 101, 601, 901 at least in part by advancing or retarding a compression ignition engine fuel injection timing. Optionally, control system 115, 615 is configured such that at least one of: (a) the compression ignition engine fuel injection timing is advanced in a dual-fuel operating mode compared to a compression ignition engine fuel-only operating mode; (b) in the dual-fuel operating mode, the compression ignition engine fuel injection timing is retarded as a load on the compression ignition engine increases; (c) the compression ignition engine fuel injection timing is retarded as an intake manifold temperature increases; and (d) an air-fuel ratio is closer to stoichiometric in the dual-fuel operating mode compared to the compression ignition engine fuel-only operating mode. Optionally, control system 115, 615 is configured for controlling the ammonia-NOx ratio downstream of the compression ignition engine 101, 601, 901 at least in part by adjusting an air-fuel ratio. Optionally, compression ignition engine system 100, 600, 900 further includes an exhaust system 103, 903 which is coupled with the compression ignition engine 101, 601, 901 and includes at least one emission reduction device 943, 113, 613, wherein the control system 115, 615 includes a first NOx sensor 117, 617, 917, a first ammonia sensor 116, 616, 916, a second NOx sensor 117, 617, 917, and a second ammonia sensor 116, 616, 916, the first NOx sensor 117, 617, 917 and the first ammonia sensor 116, 616, 916 being positioned upstream of the at least one emission reduction device 943, 113, 613, the second NOx sensor 117, 617, 917 and the second ammonia sensor 116, 616, 916 being positioned downstream of the at least one emission reduction device 943, 113, 613. Optionally, control system 115, 615 is configured for controlling a power output of the compression ignition engine 101, 601, 901 at least in part by at least one of: (a) increasing or decreasing a quantity of the compression ignition engine fuel at a plurality of engine load requests that are low; (b) increasing or decreasing a quantity of ammonia at a plurality of engine load requests higher than a compression ignition engine fuel-only operating mode; and (c) determining an ideal fuel energy split between the ammonia and the compression ignition engine fuel.

It is to be understood that the steps of method 1160 are performed by controller 118, 618, 619 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by controller 118, 618, 619 described herein, such as the method 1160, is implemented in software code or instructions which are tangibly stored on a tangible computer readable medium. The controller 118, 618, 619 loads the software code or instructions via a direct interface with the computer readable medium or via a wired and/or wireless network. Upon loading and executing such software code or instructions by controller 118, 618, 619, controller 118, 618, 619 may perform any of the functionality of controller 118, 618, 619 described herein, including any steps of the method 1160.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A compression ignition engine system, comprising:
a compression ignition engine which is configured for using ammonia as a primary fuel source and a compression ignition engine fuel as a secondary fuel source; and
a control system operatively coupled with the compression ignition engine and configured for at least partially controlling a use of the ammonia and the compression ignition engine fuel by the compression ignition engine, the compression ignition engine system having an absence of an exhaust gas recirculation system or an absence of an exhaust gas recirculation system that functions.

2. The compression ignition engine system according to claim 1, wherein the control system is configured for controlling an ammonia-NOx ratio downstream of the compression ignition engine at least in part by advancing or retarding a compression ignition engine fuel injection timing.

3. The compression ignition engine system according to claim 2, wherein the control system is configured such that at least one of:
(a) the compression ignition engine fuel injection timing is advanced in a dual-fuel operating mode compared to a compression ignition engine fuel-only operating mode;
(b) in the dual-fuel operating mode, the compression ignition engine fuel injection timing is retarded as a load on the compression ignition engine increases;
(c) the compression ignition engine fuel injection timing is retarded as an intake manifold temperature increases; and
(d) an air-fuel ratio is closer to stoichiometric in the dual-fuel operating mode compared to the compression ignition engine fuel-only operating mode.

4. The compression ignition engine system according to claim 2, wherein the control system is configured for controlling the ammonia-NOx ratio downstream of the compression ignition engine at least in part by adjusting an air-fuel ratio.

5. The compression ignition engine system according to claim 1, further including an exhaust system which is coupled with the compression ignition engine and includes at least one emission reduction device, wherein the control system includes a first NOx sensor, a first ammonia sensor, a second NOx sensor, and a second ammonia sensor, the first NOx sensor and the first ammonia sensor being positioned upstream of the at least one emission reduction device, the second NOx sensor and the second ammonia sensor being positioned downstream of the at least one emission reduction device.

6. The compression ignition engine system according to claim 1, wherein the control system is configured for controlling a power output of the compression ignition engine at least in part by at least one of:
(a) increasing or decreasing a quantity of the compression ignition engine fuel at a plurality of engine load requests that are low;
(b) increasing or decreasing a quantity of ammonia at a plurality of engine load requests higher than a compression ignition engine fuel-only operating mode; and
(c) determining an ideal fuel energy split between the ammonia and the compression ignition engine fuel.

7. A control system for a compression ignition engine system including a compression ignition engine, the control system comprising:
the control system, which is configured for being operatively coupled with the compression ignition engine—which is configured for using ammonia as a primary fuel source and a compression ignition engine fuel as a secondary fuel source—and for at least partially controlling a use of the ammonia and the compression ignition engine fuel by the compression ignition engine of the compression ignition engine system, which has an absence of an exhaust gas recirculation system or an absence of an exhaust gas recirculation system that functions.

8. The control system according to claim 7, wherein the control system is configured for controlling an ammonia-NOx ratio downstream of the compression ignition engine at least in part by advancing or retarding a compression ignition engine fuel injection timing.

9. The control system according to claim 8, wherein the control system is configured such that at least one of:
(a) the compression ignition engine fuel injection timing is advanced in a dual-fuel operating mode compared to a compression ignition engine fuel-only operating mode;
(b) in the dual-fuel operating mode, the compression ignition engine fuel injection timing is retarded as a load on the compression ignition engine increases;
(c) the compression ignition engine fuel injection timing is retarded as an intake manifold temperature increases; and
(d) an air-fuel ratio is closer to stoichiometric in the dual-fuel operating mode compared to the compression ignition engine fuel-only operating mode.

10. The control system according to claim 8, wherein the control system is configured for controlling the ammonia-NOx ratio downstream of the compression ignition engine at least in part by adjusting an air-fuel ratio.

11. The control system according to claim 7, wherein the control system includes a first NOx sensor, a first ammonia sensor, a second NOx sensor, and a second ammonia sensor, the first NOx sensor and the first ammonia sensor being positioned upstream of at least one emission reduction device of an exhaust system coupled with the compression ignition engine, the second NOx sensor and the second ammonia sensor being positioned downstream of the at least one emission reduction device.

12. The control system according to claim 7, wherein the control system is configured for controlling a power output of the compression ignition engine at least in part by at least one of:
(a) increasing or decreasing a quantity of the compression ignition engine fuel at a plurality of engine load requests that are low;
(b) increasing or decreasing a quantity of ammonia at a plurality of engine load requests higher than a compression ignition engine fuel-only operating mode; and
(c) determining an ideal fuel energy split between the ammonia and the compression ignition engine fuel.

13. A method of forming and using a compression ignition engine system, the method comprising the steps of:
providing that the compression ignition engine system includes a compression ignition engine, which is configured for using ammonia as a primary fuel source and a compression ignition engine fuel as a secondary fuel source;
operatively coupling a control system with the compression ignition engine; and
controlling, at least partially, a use of the ammonia and the compression ignition engine fuel by the compression ignition engine, the compression ignition engine system having an absence of an exhaust gas recirculation system or an absence of an exhaust gas recirculation system that functions.

14. The method according to claim 13, wherein the control system is configured for controlling an ammonia-NOx ratio downstream of the compression ignition engine at least in part by advancing or retarding a compression ignition engine fuel injection timing.

15. The method according to claim 14, wherein the control system is configured such that at least one of:
(a) the compression ignition engine fuel injection timing is advanced in a dual-fuel operating mode compared to a compression ignition engine fuel-only operating mode;
(b) in the dual-fuel operating mode, the compression ignition engine fuel injection timing is retarded as a load on the compression ignition engine increases;
(c) the compression ignition engine fuel injection timing is retarded as an intake manifold temperature increases; and
(d) an air-fuel ratio is closer to stoichiometric in the dual-fuel operating mode compared to the compression ignition engine fuel-only operating mode.

16. The method according to claim 14, wherein the control system is configured for controlling the ammonia-NOx ratio downstream of the compression ignition engine at least in part by adjusting an air-fuel ratio.

17. The method according to claim 13, wherein the compression ignition engine system further includes an exhaust system which is coupled with the compression ignition engine and includes at least one emission reduction device, wherein the control system includes a first NOx sensor, a first ammonia sensor, a second NOx sensor, and a second ammonia sensor, the first NOx sensor and the first ammonia sensor being positioned upstream of the at least one emission reduction device, the second NOx sensor and the second ammonia sensor being positioned downstream of the at least one emission reduction device.

18. The method according to claim 13, wherein the control system is configured for controlling a power output of the compression ignition engine at least in part by at least one of:
(a) increasing or decreasing a quantity of the compression ignition engine fuel at a plurality of engine load requests that are low;
(b) increasing or decreasing a quantity of ammonia at a plurality of engine load requests higher than a compression ignition engine fuel-only operating mode; and
(c) determining an ideal fuel energy split between the ammonia and the compression ignition engine fuel.
